(19) United States
(12) Patent Application Publication
(10) Pub. No.: US 2012/0142326 A1
(43) Pub. Date: Jun. 7, 2012

(54) Method and Apparatus for Triggering Group Intelligence Service of Mobile Access Hunting

(75) Inventors: Duancheng Song, Shenzhen (CN); Minggui Yang, Shenzhen (CN); Yan Chen, Shenzhen (CN)

(73) Assignee: ZTE CORPORATION, Shenzhen City, Guangdong Province (CN)

(21) Appl. No.: 13/389,532

(22) PCT Filed: May 13, 2010
(86) PCT No.: PCT/CN2010/072752

§ 371 Date: Feb. 8, 2012

(30) Foreign Application Priority Data
Aug. 27, 2009 (CN) 200910090583.0

(51) Int. Cl. H04W 4/16

(52) U.S. Cl. 455/417

(57) ABSTRACT

A method for triggering a Mobile Access Hunting (MAH) group intelligent service is disclosed in the present invention. The method comprises: a Mobile Switching Center (MSC) sends an analysis information request message for triggering a Called-Routing-Address-Available trigger to a Service Control Point (SCP), wherein said analysis information request message carries indication information of MAH group intelligent service; and after receiving the answer from the connection number, the MSC sends a called answer request message for triggering a T_Answer trigger to the SCP, wherein the called answer request message carries a destination number and redirection indication information, which instruct the SCP to perform charging. An apparatus for implementing said method for triggering MAH group intelligent service is also disclosed in the present invention. The present invention achieves the triggering and charging of MAH group intelligent service, thus enriching and extending MAH group services.

### TECHNICAL FIELD

The present invention relates to an access technology of Mobile Access Hunting (MAH) group intelligent service, and especially, to a method and apparatus for triggering MAH group intelligent service.

### BACKGROUND OF THE RELATED ART

MAH refers that a user binds a group of numbers by using a certain number as a pilot Directory Number (DN), and when other users dial the pilot DN, all the numbers in that group are sequentially ringing, and once one member answers, the hunting of the next member is stopped. The detailed procedure refers to reference 6.14 in protocol 41D <TIA41D-with-enhancements-4-bro.pdf>.

Protocol 41D for MAH service only involves the procedures for a normal user, and does not include the triggering procedures of group intelligence (triggering an intelligent call by the pilot DN). On the other hand, the protocols related to intelligence, such as IS826, only involve the basic call services, and the processing on MAH service is not mentioned, such that the problems are remained as follows:

According to the description of the above protocols 41D and IS826, if a MAH pilot DN subscribes to intelligent services in a Home Location Register (HLR), the existing triggering procedure of MAH group intelligent service is shown in FIG. 1. As shown in FIG. 1, The triggering procedure of MAH group intelligent service comprises the following steps:

Step 101: a user dials the pilot DN.

Step 102: the Mobile Switching Center (MSC) MSC1 analyzes that the pilot DN is a mobile number, then sends a location request message to the HLR the number belongs to, wherein the message carries the pilot DN and the Mobile_Termination trigger.

Step 103: the HLR determines that the number carried in the location request message is a pilot DN of an MAH group and has subscribed to intelligent services, also that the Mobile_Termination trigger is carried in the message, then responds with a location request response message carrying an address list of triggers which the pilot DN has subscribed to {Initial_Termination, Location, Called_Routing_Address_Available, T_Answer, T_Disconnect}.

Step 104: the MSC1 sends an analysis information request message carrying the pilot DN and the Initial_Termination trigger to the Service Control Point (SCP).

Step 105: the SCP sends an analysis information response message to MSC1 after the authentication for the pilot DN succeeds.

Step 106: the MSC1 sends a location request message to its HLR, wherein the location request message carries the pilot DN and the Location trigger.

Step 107: the HLR determines that the trigger carried in the location request message is Location and the number carried in the location request message is a pilot DN, and the HLR further recognizes the first connection number in the MAH group is a landline number 1, and then the HLR sends the landline number 1 to MSC1 by a location request response message.

Step 108: the MSC1 continues sending the analysis information request message, triggering the Called_Routing_Address_Available trigger.

Step 109: the SCP sends the analysis information response message to MSC1, confirming the analysis information request message has been received.

In this case the problem is that, for a normal intelligent call, the SCP performs charging based on the location information of the called carried in the analysis information request message, but the intelligent service herein is triggered by the pilot DN, and which number in the MAH group is to be connected in the end has not been determined yet, thus MSC1 can not carry the location information of the called to the SCP, then the SCP can not perform charge-rate matching and charging on the pilot DN account subsequently. Since the existing protocols do not depict this situation, the SCP can not process the analysis information request message, which may cause the access failure of the intelligent service for the whole MAH group.

### SUMMARY OF THE INVENTION

In view of above, the main purpose of the present invention is to provide a method and apparatus for triggering mobile access hunting (MAH) group intelligent service, which allows the normal triggering of the MAH group intelligent service and performs the accurate charging.

To achieve the above purpose, the technical scheme in the present invention is realized as follows:

A method for triggering MAH group intelligent service, comprising:

a Mobile Switching Center (MSC) sending an analysis information request message for triggering a Called_Routing_Address_Available trigger to Service Control Point (SCP), wherein the analysis information request message carries indication information of MAH group intelligent service; after receiving an answer from a connection number, the MSC sending a called answer request message for triggering a T_Answer trigger to the SCP, instructing the SCP to charge, wherein the called answer request message carries a destination number and redirection indication information.

Preferably, the method further comprises:

when the connection to the connection number fails, the MSC sending a number redirection request message to Home Location Register (HLR), originating a connection to a next number in the MAH group.

Preferably, the called answer request message further carries number redirection information.

Preferably, when the connection number which answers is a landline number, a destination number in the called answer request message is the landline number, and the redirection indication information is identification information for accessing Public Switched Telephone Network (PSTN); when the connection number which answers is a local office mobile number, the destination number in the called answer request message is the local office mobile number, and the redirection indication information is the identification information for accessing a local office network.

Preferably, when the connection number which answers is a foreign office mobile number, the destination number in the called answer request message is a temporary roaming number of the mobile number, the redirection number is the mobile number, and the redirection indication information is the identification information for accessing an unknown network; when the connection number which answers is a landline number, the destination number in the called answer request message is the landline number, the redirection number is the landline number, and the redirection indication information is the identification information for accessing the PSTN; when the connection number is a local office mobile number, the destination number in the called answer request message is the mobile number, the redirection number is the local office mobile number, and the redirection indication information is the identification information for accessing the local office network.

An apparatus for triggering MAH group intelligent service, comprising:

a first transmission unit, configured to send an analysis information request message for triggering a Called_Routing_Address_Available trigger to SCP, wherein the analysis information request message carries indication information of MAH group intelligent service;

a receiving unit, configured to receive an answer from a connection number; and

a second transmission unit, configured to send a called answer request message for triggering a T_Answer trigger to the SCP after the receiving unit receives the answer from the connection number, instructing the SCP to charge, wherein the called answer request message carries a destination number and redirection indication information.

Preferably, the apparatus further comprises:

a third transmission unit, configured to send a number redirection request message to when the connection to the connection number fails, triggering a connection to a next number in the MAH group.

Preferably, the called answer request message further carries number redirection information.

Preferably, when the connection number which answers is a landline number, the destination number in the called answer request message is the landline number, and the redirection indication information is the identification information for accessing the PSTN; when the connection number which answers is a local office mobile number, the destination number in the called answer request message is the local office mobile number, and the redirection indication information is the identification information for accessing a local office network.

Preferably, when the connection number which answers is a foreign office mobile number, the destination number in the called answer request message is a temporary roaming number of the mobile number, the redirection number is the mobile number, and the redirection indication information is the identification information for accessing an unknown network; when the connection number which answers is a landline number, the destination number in the called answer request message is the landline number, the redirection number is the landline number, and the redirection indication information is the identification information for accessing the PSTN; when the connection number is a local office mobile number, the destination number in the called answer request message is the mobile number, the redirection number is the local office mobile number, and the redirection indication information is the identification information for accessing the local office network.

In the present invention, when MSC sends an analysis information request message for triggering the Called_Routing_Address_Available trigger to SCP, the message carries the indication information of MAH group intelligent service. When SCP receives the indication information of the MAH group intelligent service, it does not trigger the charging procedure for the current call. After receiving the answer from the connection number, MSC sends a called answer request message for triggering the T_Answer trigger to SCP, which achieves the connection to the connection number and instructs SCP to charge, wherein the message carries the destination number and redirection indication information. The present invention enables the triggering and charging on MAH group intelligent service, thus enriching and extending MAH group services.

### BRIEF DESCRIPTION OF DRAWINGS

FIG. 1 is a triggering flow diagram of the existing MAH group intelligent service;

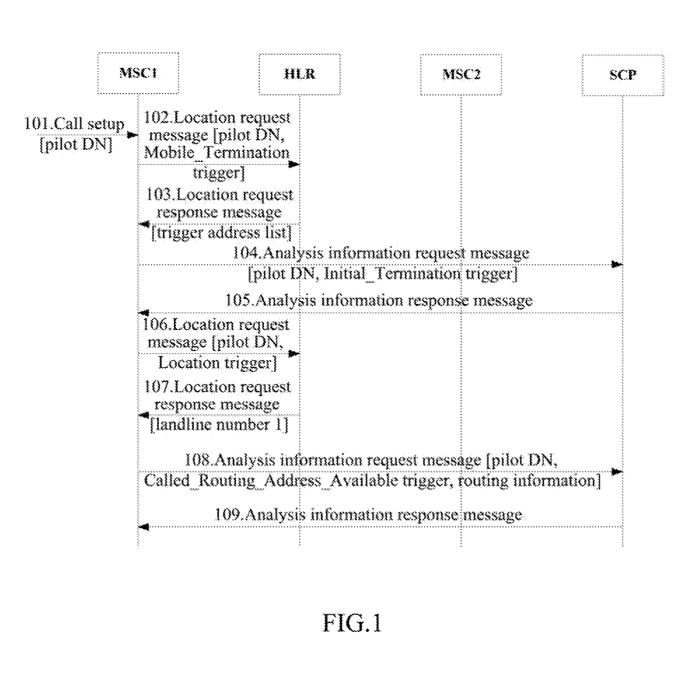

FIG. 2 is a triggering flow diagram of the intelligent service when a landline number user in MAH group answers in the present invention;

FIG. 3 is a triggering flow diagram of the intelligent service when a foreign office mobile user answers in the case that the connection to a landline number in MAH group fails in the present invention;

FIG. 4 is a triggering flow diagram of the intelligent service when a local office mobile user answers in the case that the connection to a landline number in MAH group fails in the present invention;

FIG. 5 is a structure schematic diagram of composition of a triggering apparatus for MAH group intelligent service in the present invention.

### SPECIFIC EMBODIMENTS

The basic conception in the present invention is: the analysis information request message MSC sends to SCP for triggering the Called_Routing_Address_Available trigger carries the indication information of the MAH group intelligent service. When SCP receives the indication information of MAH group intelligent service, it does not trigger the charging procedure for the current call. After receiving the answer from the connection number, MSC sends a called answer request message for triggering the T_Answer trigger to SCP, which achieves the connection to the connection number and instructs SCP to charge, wherein the called answer request message carries the destination number and redirection indication information. The present invention enables the triggering and charging on MAH group intelligent service, thus enriching and extending MAH group services.

In order to depict the purpose, technical solutions and advantages of the present invention more clearly, the following embodiments combining with figures of the present invention provide the detailed description below.

In the present invention, the value of the FeatureIndicator field in reference 6.4.88 of protocol IS124 needs to be extended. Currently, the field in the protocol is defined as below in table 1:

TABLE 1

| | | |
|---|---|---|
| answerHold^{b} | 37 | answer hold |
| userSelectiveCallForwarding^{b} | 38 | user selective call |
| | | forwarding |
| — | negative values | reserved for bilateral |
| | | agreements |
| — | other positive values | reserved |

As shown in table 1, indication information for one MALI group intelligent service is added in the FeatureIndicator field in the present invention, so as to indicate the current service is the MAH group intelligent service. For example, the code value of the indication information is set as 40, i.e. 40: mobileAccessHuntingGroup. The configuration of the code value obeys the rule of not conflicting with the existing indication codes, and no specific value is defined. The above is only illustrative description.

Furthermore, the T_Answer message (T_Answer trigger) in protocol IS826 also needs to be extended, and the specific way is as follows:

1) one optional parameter DestinationDigit (destination number) is added, so as to denote the final connection number;

2) one optional parameter RedirectingNumberDigit (redirection number) is added, so as to indicate the redirection user number corresponding to a TLDN (Temporary Local Directory Number) when the TLDN is outgoing. When the connection number is a landline number or a local office mobile number, the RedirectingNumberDigit parameter is filled with the currently connecting landline number or local office mobile number, or the parameter is not configured.

3) one optional parameter DMH_RedirectionIndicator (redirection indicator) is added, so as to denote the type of the call redirected for the last time, i.e. the access network of the connection number after the redirection.

The detailed structure of the extended T_Answer message is shown in table 2, wherein the bold italic parts are the extended parameters.

TABLE 2
TAnswer INVOKE Parameter

| Field | Value | Type | Reference | Note |
|---|---|---|---|---|
| Identifier | SET [NATIONAL 18] | M | 6.3.2.1 | |
| Length | variable octet | M | 6.3.2.1 | |

Content

| | | | |
|---|---|---|---|
| BillingID (Originating) | M | 6.5.2.16 | a |
| ElectronicSerialNumber | M | 6.5.2.63 | b |
| MSCID | M | 6.5.2.82 | c |
| MSID | M | 6.5.2.bv | b |
| TimeDateOffset | M | 6.5.2.dd | d |
| TimeOfDay | M | 6.5.2.em | e |
| TransactionCapability | M | 6.5.2.160 | |
| TriggerType | M | 6.5.2.dh | f |
| WINCapability | M | 6.5.2.di | |
| LocationAreaID | O | 6.5.2.77 | g, h |
| MobileDirectoryNumber | O | 6.5.2.80 | i |
| FeatureIndicator | O | 6.5.2.ej | j |
| MSCIdentificationNumber | O | 6.5.2.83 | k |
| ServingCellID | O | 6.5.2.117 | g, l |
| SystemMyTypeCode | O | 6.5.2.147 | |
| TerminationAccessType | O | 6.5.2.155 | m |
| [symbol] | [symbol] | [symbol] | |
| [symbol] | [symbol] | [symbol] | |
| [symbol] | [symbol] | [symbol] | |

When MSC triggers the Called_Routing_Address_Available trigger, it carries the FeatureIndicator parameter instead of routing information, the value of which is 40 indicating the current service is the MAH group intelligent service, thus instructing SCP not to calculate charge-rate and not to charge.

After one user number in the MAH group answers, MSC triggers the T_Answer trigger to SCP. The details are as follows: if the user who answers has a landline number, DestinationDigit is filled with the landline number; RedirectingNumberDigit is set as Null or not configured; and DMH_RedirectionIndicator is set as 6 indicating accessing the PSTN (Public Switched Telephone Network). If the user who answers is a foreign office mobile user, DestinationDigit is filled with the temporary roaming number allocated to the mobile user; RedirectingNumberDigit is filled with the MDN of the mobile user; and DMH_RedirectionIndicator or is set as 5, indicating accessing an unassigned network.

If the user who answers is a local office mobile user, DestinationDigit is filled with the number of the mobile user; RedirectingNumberDigit is also filled with the number of the mobile user; and DMH_RedirectionIndicator is set as 23, indicating accessing the local office. Note: when the connection number is a local office mobile number, the RedirectingNumberDigit parameter also can be not configured or set as Null.

After triggered by the T_Answer trigger, SCP can obtain the final location information of the called, then perform the corresponding charging procedure.

In the illustration of the present invention, take the MAH group comprising three members as a example for description, wherein three members are respectively: 1: landline user; mobile number 2: foreign office user served by an HLR; mobile number 3: local office user served by the HLR. The following further depicts the essence of the technical solutions in the present invention by the detailed illustrations.

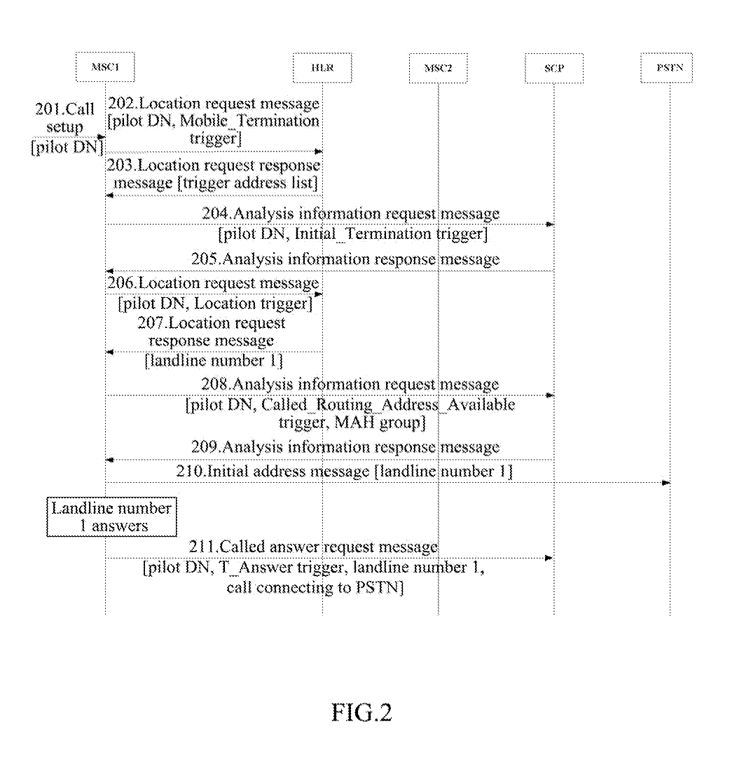

FIG. 2 is a triggering flow diagram of the intelligent service when a landline number user in MAH group answers in the present invention. As shown in FIG. 2, the illustrative triggering procedure for the intelligent service comprises the following steps:

Step 201: a user dials the pilot DN.

Step 202: MSC1 analyzes the pilot DN is a mobile number, then sends a location request message to the HLR the number belongs to, wherein the message carries the pilot DN and the Mobile_Termination trigger.

Step 203: the FUR determines that the pilot DN has subscribed to intelligent services and the Mobile_Termination trigger is carried, then responds to MSC1 with a location request response message carrying an address list of the triggers which the pilot DN has subscribed to {Initial_Termination. Location, Called_Routing_Address_Available, T_Answer, T_Disconnect}.

Step 204: MSC1 sends an analysis information request message carrying the pilot DN and the Initial_Termination trigger to SCP.

Step 205: SCP sends an analysis information response message to MSC1 after the authentication for the pilot DN succeeds.

Step 206: MSC1 sends a location request message to HLR which the MSC1 belongs to, wherein the location request message carries the pilot DN and the Location trigger.

Step 207: the HLR determines the trigger carried in the location request message is Location and the number carried in the location request message is a pilot DN, and further analyzes the first connection number 1 in the MAH group is a landline number user, and then the HLR sends the landline number 1 to MSC1 by a location request response message.

Note: the first connection number in the MAH group in the present invention may also be a local office mobile number or a foreign office mobile number. The essence of implementing the technical solutions in the present invention does not change regardless of the types of the number.

Step 208: MSC1 continues sending the analysis information request message, triggering the Called_Routing_Address_Available trigger. MSC1 discovers that the service currently triggered is the MAH group intelligent service. According to the above description of the parameters' extension, the analysis information request message includes the FeatureIndicator parameter and its value is 40, which indicates the current service is the MAH group intelligent service and instructs SCP not to perform the charging procedure.

Step 209: SCP determines the current service is the MAH group intelligent service, so it does not calculate the charge-rate and not charge, and directly sends the analysis information response message to MSC1.

Step 210: MSC1 sends an Initial Address Message to PSTN and connects landline number 1.

Step 211: After receiving the answer message of the landline number 1, MSC1 sends a called answer request message to SCP, triggering the T_Answer trigger to SCP, wherein DestinationDigit is filled with the landline number 1; the RedirectingNumberDigit parameter is not carried; and DMH_RedirectionIndicator is set as 6, indicating accessing the PSTN. Note: when the connection number is a landline number, the RedirectingNumberDigit parameter also can be configured in TAnswer message in the present invention, but generally the parameter is set as Null. When the connection number is a local office mobile number, similar to the case of landline number, the RedirectingNumberDigit parameter can be not configured or set it as Null. If the RedirectingNumberDigit parameter is configured, it can be filled with the landline number or the local office mobile number, which means the content filled in is the same as that of the DestinationDigit parameter, i.e. in this case the parameters filled in the item of destination number and the item of redirection number are the same. When the connection number is a foreign office mobile number, since the MSC serving the foreign office mobile number has allocated a roaming number for the foreign office mobile number, the RedirectingNumberDigit parameter should be configured, and the parameter needs to be filled with the foreign office mobile number; the DestinationDigit parameter should be filled with the roaming number; and the content filled in the DMH_RedirectionIndicator parameter varies with different destination numbers, for example, the value is set as 6 in the case of a landline number, 23 in the case of a local office mobile number, and 5 in the case of a foreign office mobile number.

Based on the DestinationDigit parameter and the DMH_RedirectionIndicator parameter in TAnswer message of the called answer request message, SCP begins the operations such as calculating charge-rate and charging and so on.

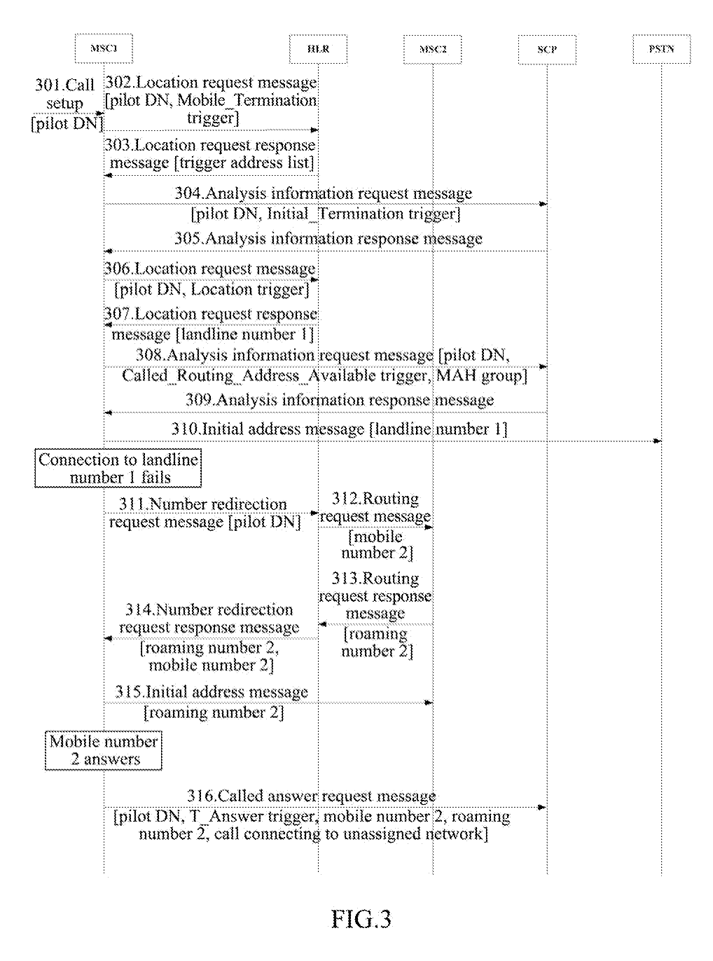

FIG. 3 is a triggering flow diagram of the intelligent service when a foreign office mobile user answers in the case that the connection to a landline number in MAH group fails in the present invention. As shown in FIG. 3, the illustrative triggering procedure for the intelligent service when a foreign office mobile user answers comprises the following steps:

Step 301 to step 310 are exactly the same as step 201 to step 210 in FIG. 2. The detailed implementation for these steps is skipped here. FIG. 3 mainly describes how to implement the connection for other bound numbers in the MAH group after the connection to a landline number fails. The following is the detailed description. Suppose that the second number to be connected in the MAH group is a foreign office mobile number in this illustration.

Step 311: when the landline number 1 fails in connection, MSC1 sends a number redirection request message carrying the pilot DN to HLR in order to acquire the next member's number which is able to be connected in the MAH group.

Step 312: HLR judges that the current call is a MAH group call and the mobile number 2 of the next member in the MAH group belongs to a foreign office, then sends a routing request message to MSC2 the mobile number 2 belongs to.

Step 313: after receiving the routing request message, MSC2 allocates a temporary roaming number 2 to mobile number 2, and sends it to HLR by the routing request response message.

Step 314: sends a number redirection response message carrying the mobile number 2 and the roaming number 2 to MSC1.

Step 315: MSC1 sends an initial address message to MSC2, connecting the mobile number 2.

Step 316: after receiving the response message of the mobile number 2, MSC1 sends a called answer request message to SCP, triggering the T_Answer trigger to SCP, wherein DestinationDigit is filled with the roaming number 2 which is allocated for the mobile number 2 by MSC2; RedirectingNumberDigit is filled with the mobile number 2; and DMH_RedirectionIndicator is set as 5, indicating accessing an unassigned network.

Based on the DestinationDigit parameter and the DMH_RedirectionIndicator parameter in the TAnswer message of the called answer request message, SCP begins the operations such as calculating charge-rate and charging and so on.

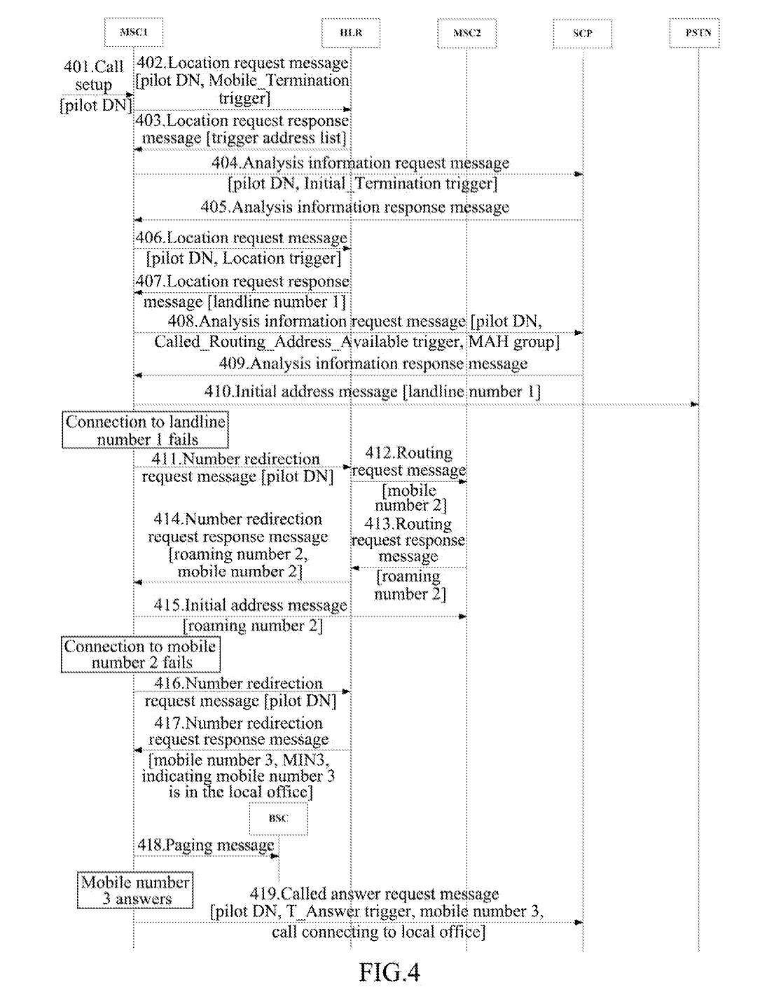

FIG. 4 is a triggering flow diagram of the intelligent service when a local office mobile user answers in the case that the connection to a landline number in MAH group fails in the present invention. As shown in FIG. 4, the illustrative triggering procedure for the intelligent service when a local office mobile user answers comprises the following steps:

Step 401 to step 415 are exactly the same as step 301 to step 315 shown in FIG. 3. The detailed implementation for these steps is skipped here. FIG. 4 mainly describes how to implement the connection for other bound numbers in the MAH group after the connection to the foreign office mobile number fails. The following is the detailed description. Suppose that the third number to be connected in the MAH group is a local office mobile number.

Step 416: when the connection to the mobile number 2 fails, MSC1 sends a number redirection request message carrying the pilot DN to HLR in order to acquire the next member's number which is able to be connected in the MAH group.

Step 417: HLR judges that the current call is a MAH group call and the mobile number 3 of the next member in the MAH group is currently within MSC1 office, then sends a number redirection response message to MSC1, wherein the response message carries the mobile number 3, Mobile Identification Number (MIN) MIN3 and the indicator indicating the mobile number 3 is in the local office.

Step 418: MSC1 sends a paging message to Base Station Controller (BSC), connecting the mobile number 3.

Step 419: after receiving the answer message of the mobile number 3, MSC1 sends a called answer request message to SCP, triggering the T_Answer trigger to SCP, wherein DestinationDigit is filled with the mobile number 3; RedirectingNumberDigit is also filled with the mobile number 3; and DMH_RedirectionIndicator is set as 23, indicating accessing the local office. Note: when the mobile number is a local office mobile number, the RedirectingNumberDigit parameter in TAnswer message may be set as null or not configured.

Based on the DestinationDigit parameter and the DMH_RedirectionIndicator parameter in the TAnswer message of the called answer request message, SCP begins the operations such as calculating charge-rate and charging and so on.

Note: in order to unify the format of TAnswer messages, TAnswer messages can be configured to include the RedirectingNumberDigit parameter. When the connection number is a landline number or a local office mobile number, RedirectingNumberDigit is filled with the landline number or the local office mobile number, or some specific meaningless bits.

The technical solutions in the present invention are applicable to the 2^{nd} generation mobile communication systems and the 3_{rd} generation mobile communication systems. In the 3^{rd} generation telecommunication systems, SCP is called SCPe (Service Control Point Emulation), HLR is called HLRe (Home Location Register Emulation), and MSC is called MSCE (Mobile Switching Center Emulation), though the implementation flows are the same.

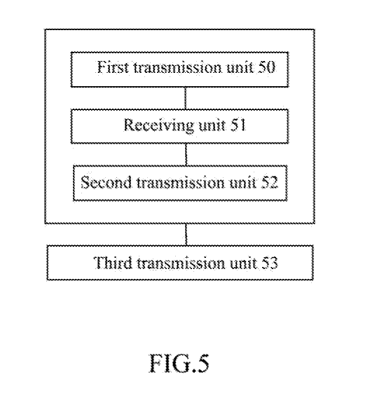

FIG. 5 is a structure schematic diagram of composition of a triggering apparatus for MAH group intelligent service in the present invention. As shown in FIG. 5, the triggering apparatus for MAH group intelligent service in the present invention comprises a first transmission unit 50, a receiving unit 51 and a second transmission unit 52. The first transmission unit 50 is used to send an analysis information request message for triggering the Called_Routing_Address_Available trigger to SCP, wherein the message carries indication information of MAH group intelligent service; the receiving unit 51 is used to receive the answer of the connection number; the second transmission unit 52 is used to send the called answer request message for triggering the T_Answer trigger to the SCP after the receiving unit 51 receives the answer of the connection number, wherein the called answer request message carries the destination number and redirection indication information which instruct the SCP to charge.

As shown in FIG. 5, the triggering apparatus for MAH group intelligent service also comprises a third transmission unit 53, which is used to, when the connection to the connection number fails, send a number redirection request message to HLR for triggering the connection of the next number in the MAH group.

When the connection number is a connection number in the MAH group or a foreign office mobile number, the called answer request message further carries number redirection information. When the connection number is a landline number, the destination number in the called answer request message is the landline number, and the redirection indication information is the identification information for accessing PSTN. When the connection number is a foreign office mobile number, the destination number in the called answer request message is the temporary roaming number of the mobile number, and the redirection number is the mobile number, and the redirection indication information is the identification information for accessing an unknown network. When the connection number is a local office mobile number, the destination number in the called answer request message is the mobile number, and the redirection indication information is the identification information for accessing the local office network. When the connection number is a landline number or a local office mobile number, the redirection number is the landline number or the local office mobile number.

For a skilled person in the art, it should be understood that the triggering apparatus for MAH group intelligent service shown in FIG. 5 in the present invention is designed for implementing the methods for triggering MAH group intelligent service shown in FIG. 2 to FIG. 4. The implementing function of each processing unit in the apparatus shown in FIG. 5 can be understood according to the related descriptions of the methods shown in FIG. 2 to FIG. 4, and the function of each processing unit can be implemented by running the programs on a processor, or by the corresponding logic circuits. For a skilled person in the art, it should be understood that the third transmission unit 53 shown in FIG. 5 is not an essential technical feature in the apparatus for triggering the MAH group intelligent service in the present invention.

The above embodiments are only preferred embodiments of the invention, and they are not intended to limit the protection scope of the invention.

What is claimed is:

1. A method for triggering Mobile Access Hunting (MAH) group intelligent service, comprising:
Mobile Switching Center (MSC) sending an analysis information request message for triggering a Called_Routing_Address_Available trigger to Service Control Point (SCP), wherein the analysis information request message carries indication information of MAH group intelligent service; after receiving an answer from a connection number, the MSC sending a called answer request message for triggering a T_Answer trigger to the SCP;
wherein the called answer request message carries a destination number and redirection indication information, which instruct the SCP to charge.

2. The method according to claim 1, further comprising:
when a connection to the connection number fails, the MSC sending a number redirection request message to Home Location Register (HLR), originating a connection to a next number in the MAH group.

3. The method according to claim 1, wherein the called answer request message further carries number redirection information.

4. The method according to claim 1, wherein
when the connection number which answers is a landline number, the destination number in the called answer request message is the landline number, and the redirection indication information is identification information for accessing Public Switched Telephone Network (PSTN);
when the connection number which answers is a local office mobile number, the destination number in the called answer request message is the local office mobile number, and the redirection indication information is identification information for accessing a local office network.

5. The method according to claim 3, wherein
when the connection number which answers is a foreign office mobile number, the destination number in the called answer request message is a temporary roaming number of the mobile number, a redirection number is the mobile number, and the redirection indication information is identification information for accessing an unknown network;
when the connection number which answers is a landline number, the destination number in the called answer request message is the landline number, the redirection number is the landline number, and the redirection indication information is identification information for accessing PSTN;
when the connection number is a local office mobile number, the destination number in the called answer request message is the mobile number, the redirection number is the local office mobile number, and the redirection indication information is identification information for accessing a local office network.

6. An apparatus for triggering MAH group intelligent service, comprising a first transmission unit, a receiving unit and a second transmission unit, wherein
a first transmission unit, configured to send an analysis information request message for triggering a Called_Routing_Address_Available trigger to SCP, wherein the analysis information request message carries indication information of MAH group intelligent service;
a receiving unit, configured to receive an answer from a connection number; and
a second transmission unit, configured to send a called answer request message for triggering a T_Answer trigger to the SCP after the receiving unit receives the answer from the connection number, wherein the called answer request message carries a destination number and redirection indication information, instructing the SCP to charge.

7. The apparatus according to claim 6, further comprising:
a third transmission unit, configured to send a number redirection request message to HLR when a connection to the connection number fails, triggering a connection to a next number in the MAH group.

8. The apparatus according to claim 6, wherein the called answer request message further carries number redirection information.

9. The apparatus according to claim 8, wherein
when the connection number which answers is a landline number, the destination number in the called answer request message is the landline number, and the redirection indication information is identification information for accessing PSTN;
when the connection number which answers is a local office mobile number, the destination number in the called answer request message is the local office mobile number, and the redirection indication information is identification information for accessing a local office network.

10. The apparatus according to claim 8, wherein
when the connection number which answers is a foreign office mobile number, the destination number in the called answer request message is a temporary roaming number of the mobile number, a redirection number is the mobile number, and the redirection indication information is identification information for accessing an unknown network;
when the connection number which answers is a landline number, the destination number in the called answer request message is the landline number, the redirection number is the landline number, and the redirection indication information is identification information for accessing PSTN;
when the connection number is a local office mobile number, the destination number in the called answer request message is the mobile number, the redirection number is the local office mobile number, and the redirection indication information is identification information for accessing a local office network.

11. The apparatus according to claim 7, wherein the called answer request message further carries number redirection information.

12. The apparatus according to claim 11, wherein
when the connection number which answers is a landline number, the destination number in the called answer request message is the landline number, and the redirection indication information is identification information for accessing PSTN;
when the connection number which answers is a local office mobile number, the destination number in the called answer request message is the local office mobile number, and the redirection indication information is identification information for accessing a local office network.

13. The apparatus according to claim 11, wherein
when the connection number which answers is a foreign office mobile number, the destination number in the called answer request message is a temporary roaming number of the mobile number, a redirection number is the mobile number, and the redirection indication information is identification information for accessing an unknown network;
when the connection number which answers is a landline number, the destination number in the called answer request message is the landline number, the redirection number is the landline number, and the redirection indication information is identification information for accessing PSTN;
when the connection number is a local office mobile number, the destination number in the called answer request message is the mobile number, the redirection number is the local office mobile number, and the redirection indication information is identification information for accessing a local office network.
